(19) United States
(12) Patent Application Publication
(10) Pub. No.: US 2013/0237121 A1
(43) Pub. Date: Sep. 12, 2013

(54) CLIP-STYLE BALLOON WEIGHT WITH IMPROVED BIASING MEMBER

(71) Applicants: David C. NELSON, Akron, OH (US); Wesley A. SCHROEDER, Seville, OH (US)

(72) Inventors: David C. NELSON, Akron, OH (US); Wesley A. SCHROEDER, Seville, OH (US)

(21) Appl. No.: 13/415,913

(22) Filed: Mar. 9, 2012

(51) Int. Cl. A63H 3/06; B23P 11/00

(52) U.S. Cl. 446/220; 29/428

(57) ABSTRACT

A clip-style balloon weight includes first and second clip members and a biasing member. The clip members are pivotally connected to one another, and the biasing member biases the clip members into contact at a clip end and away from one another at a squeeze end. The biasing member may be formed of a non-metallic material suitable to provide a biasing force. The biasing member may include projections at the ends of opposing arms, and the clip members may include recesses and ramped surfaces extending from the recesses, the projections engaging the ramped surfaces upon insertion of the biasing member to guide the projections into the recesses, thereby assembling the balloon weight.

### FIELD OF THE INVENTION

This disclosure relates generally to a clip-style balloon weight. More particularly, this disclosure relates to a clip-style balloon weight having a plastic biasing member that facilitates quick and easy assembly of the clip a sleek and aesthetically appealing look to the weight.

### BACKGROUND OF THE INVENTION

Lighter-than-air balloons may be displayed singly or in groups both for decorative purposes as well as to celebrate various events, functions, etc. For example, one or more balloons are frequently used as centerpieces at various functions, and may include bright colors or inscribed images or messages reflecting the nature of the event or function. Both mylar and latex balloons are frequently filled with helium to render them lighter-than-air. Helium, which is a lighter-than-air gas, causes an upward lift to act on the balloon. Therefore, balloons filled with helium frequently need to be tied by means of a string or otherwise secured to an object to prevent them from floating away.

Lighter-than-air balloons are often tethered down by tying one end of a string to the balloon and an opposite end to a weighted object or stationary surface. In certain circumstances, the balloon may be tethered to a permanent surface or fixture. In other circumstances, the balloon may be tethered to a balloon weight that acts as an anchor to prevent the balloon from floating away.

One type of balloon weight simply includes a weighted object having an attachment point for securing a string to the weight. These balloon weights may rest on top of a surface and, by virtue of the weight of the object, keep the balloon from floating away. Another type of balloon weight is a clip-style balloon weight in which a clip member is adapted to squeeze or clamp an object by virtue of a biasing force. The clip-style balloon weight also includes an attachment point for securing a string to the weight. The clip-style balloon weights are advantageous in that they can act as an anchor to prevent the lighter-than-air balloons from floating away by virtue of their weight and/or by virtue of the clamping force applied to a fixed surface or object.

Known clip-style balloon weights are effective for their intended purpose, but suffer from manufacturing limitations. Conventional clip-style balloon weights, such as that disclosed in U.S. Pat. No. 7,850,506, utilize a metal spring biasing member that provides the biasing force to the clip-style balloon weight. The clip-style balloon weight including a metal spring can be difficult to assemble, thereby adding time and costs to the manufacturing process. The circular metal springs also jut out beyond the main profile of the clip-style weight, resulting in a less pleasing appearance.

Thus, there is a need for an improved clip-style balloon weight that alleviates one or more of the deficiencies of the prior art.

### SUMMARY OF THE INVENTION

In general, a balloon weight according to the present invention includes a first clip member; a second clip member pivotable relative to said first clip member; and a generally U-shaped biasing member engaged with both said first and second clip members to bias said clip members into touching engagement at a clip end and away from one another at a squeeze end, the biasing member being formed of a non-metallic material.

In accordance with at least one aspect of the present invention, a balloon weight includes a first clip member having a recess and a ramped surface adjacent said recess; a second clip member having a recess and a ramped surface adjacent said recess, said second clip member being pivotable relative to said first clip member; a biasing member including arms extending from opposite ends of an arcuate connecting portion, each arm including a projection at an end opposite the connecting portion received in one of the recesses of the first and second clip members.

In accordance with at least one aspect of the present invention, a method of assembling a balloon weight includes the steps of positioning first and second clip members together so that clip ends of the clip members are in contact and hinge portions of the clip members engage one another to pivotally connect the clip members, each of the clip members including a recess and a ramped surface extending from the recess; applying a force adjacent to the clip ends to maintain the clip members in position; and inserting a biasing member between the clip members toward the clip end, the biasing member including inwardly extending projections at opposing ends adapted to engage the ramped surfaces of the clip members to guide the projections into the recesses, thereby securing the biasing member to the clip members.

### BRIEF DESCRIPTION OF THE DRAWINGS

For a full understanding of the invention reference should be made to the following detailed description and the accompanying drawings, wherein:

FIG. 1 is a perspective view of a clip-style balloon weight according to the concepts of the present disclosure;

FIG. 2 is a front view of the clip-style balloon weight of FIG. 1;

FIG. 3 is a side view of the clip-style balloon weight of FIG. 1;

FIG. 4A is a perspective view of the biasing member of the clip-style balloon weight according to the concepts of the present disclosure;

FIG. 4B is another perspective view of the biasing member of the balloon weight according to the concepts of the present disclosure;

FIG. 5A is a sectional view showing the clip-style balloon weight in an unassembled state;

FIG. 5B is a sectional view showing the clip-style balloon weight in a partially assembled state; and

FIG. 5C is a sectional view showing the fully assembled clip-style balloon weight taken generally along line 5C-5C of FIG. 2.

### DETAILED DESCRIPTION OF THE ILLUSTRATIVE EMBODIMENTS

The clip-style balloon weight of the present invention utilizes a biasing member made from a non-metallic material having sufficient elasticity and resiliency to replace conventional metal springs. In certain embodiments, the biasing member may include arms extending from opposing ends of a generally U-shaped connecting portion, the arms each adapted to engage one of two hinged clip members. In one or more embodiments, the clip members may include ramped surfaces leading to recesses, and the arms of the biasing member may include projections at each end, the ramped surfaces and projections acting to allow quick and easy assembly of the clip-style balloon weight.

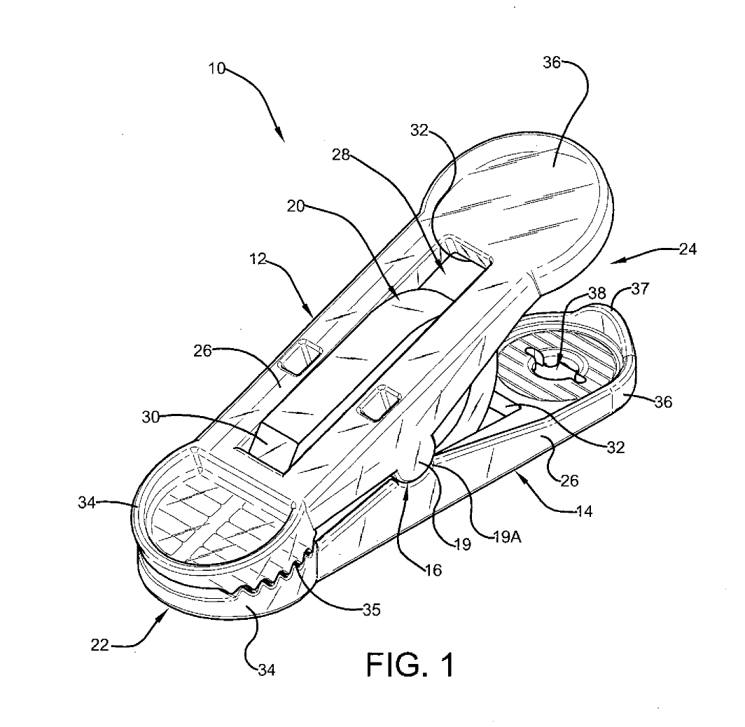

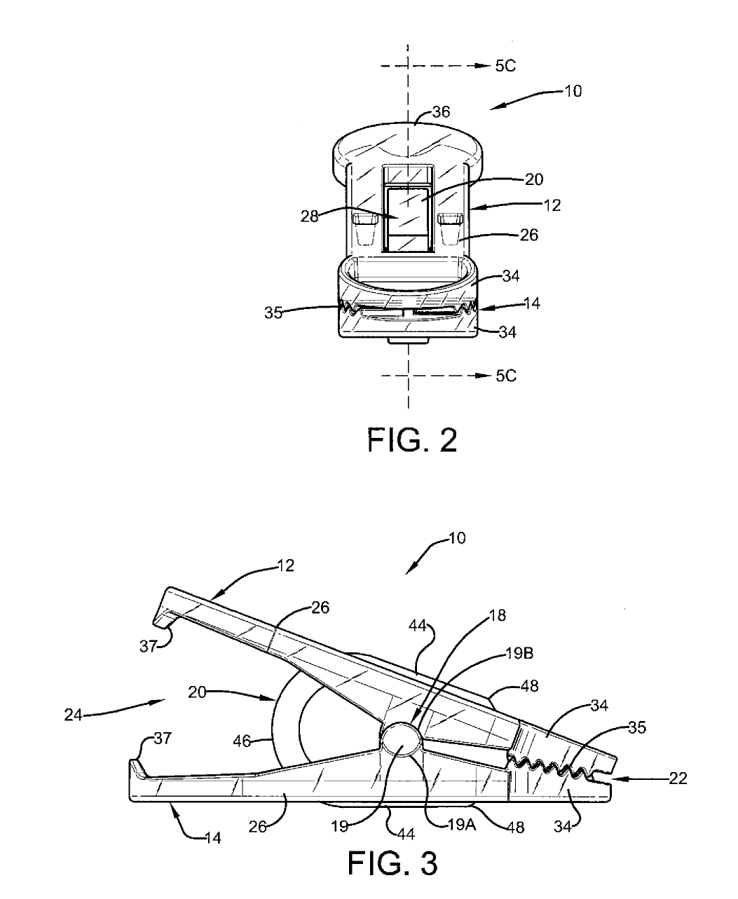

Referring now to FIG. 1, a clip-style balloon weight (hereinafter clip weight) is shown, and is generally indicated by the numeral 10. The clip weight 10 may be sized and configured to clamp onto any desired object or fixture. Clip weight 10 includes a first clip member 12 and a second clip member 14 pivotable relative to the first clip member. First and second hinge connections 16 and 18 may be provided and may act to hingedly secure the first and second clip members 12, 14 to one another.

It is contemplated that any known hinge mechanism may be provided to hingedly secure the first and second clip members 12 and 14 together. In the particular embodiment shown, clip member 12 may include a pair of projecting fins 19 at each hinge connection (only one visible). These fins are laterally spaced one from the other. The other clip member 14 includes a single projecting fin 19a adapted to be received between the pair of fins (not shown). Preferably, the pair of fins 19 are laterally spaced at a distance substantially equal to but slightly larger than the thickness of the single projection fin 19a so as to intimately receive the fin 19a between them. In other embodiments, clip member 12 may include a pair of fins 19 at one hinge connection 16 or 18, and clip member 14 may include a pair of fins 19 at the other hinge connection 16 or 18, with a single projection fin 19a being provided at the opposing clip member opposite the pair of fins 19 at each hinge connection 16 and 18. Thus, each hinge connection 16, 18 may include three adjacent fins, the outer fins spaced from one another and extending from a common clip member, and the middle fin received therebetween and extending from the other clip member. The edges 19b of the fins, or portions thereof, may be radiused to facilitate pivoting of the first and second clip members relative to one another. However, while a particular hinge mechanism is described herein and shown in the drawings, it is contemplated that other hinge structures known to those skilled in the art may be employed to pivotally connect the clip members 12 and 14.

The first and second clip members 12, 14 are biased by a biasing member 20 to be in close proximity to each other at a clip end 22 and spaced from one another at a squeeze end 24. This arrangement permits the clip weight to be squeezed at the squeeze end 24 to place the clip weight around a fixture and thereafter be released so that the clip end 22 clamps onto the fixture. In a particular embodiment, the biasing member 20 may exert a force on the clip members 12, 14 that acts to maintain the hinge connections 16 and 18 in a mating relationship.

Each of the first and second clip members 12 and 14 includes a body 26 and a longitudinally extending slot 28 in the body. The slot 28 extends from a forward end 30 adjacent the clip end 22 to a rearward end 32 adjacent the squeeze end 24. A clamping tab 34 may be provided at the clip end 22 of each clip member 12, 14 to facilitate clamping of the clip weight to a fixture. The clamping tabs 34 may optionally include a plurality of teeth 35 on an inner surface, the teeth 35 of the first and second clip members 12, 14 mating with one another when the clip end is closed. The mating teeth 35 will facilitate gripping when mounted to a fixture.

A squeezing tab 36 may be provided at the squeeze end 24 of each clip member 12, 14, the squeezing tabs 36 adapted to facilitate gripping of the clip members by a user. Stops 37 may extend inwardly from each of the squeezing tabs 36 and may be aligned with one another to limit the range of motion of the clip members 12 and 14. In certain embodiments, a hole 38 may be provided in one or both of the squeezing tabs 36 to allow a string or ribbon extending from a balloon to be easily secured to the clip weight 10. A spool member might be employed in other embodiments such as that disclosed in U.S. Pat. No. 7,850,506.

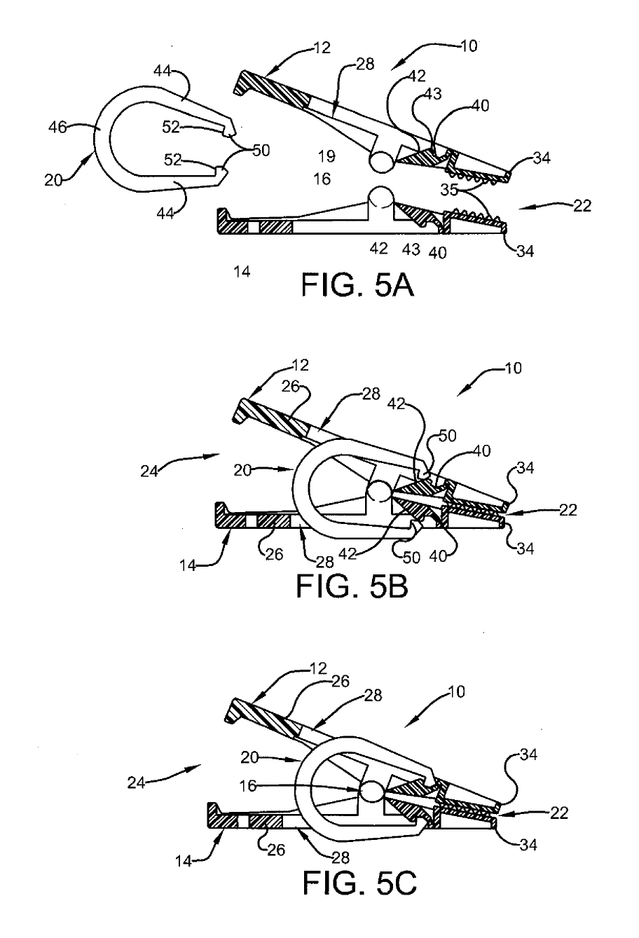

As best shown in FIGS. 5A-5C, each of the clip members 12 and 14 includes an open ended recess 40 or cup at the forward end of the slot 28 adjacent to the clip end 22. Ramped surfaces 42 are provided that extend from the recess 40 at an angle relative to the body 26 of the clips 12, 14. The ramped surfaces 42 terminate at a peak 43 that is adjacent to the recess 40. Each of the ramped surfaces 42 is adapted to facilitate assembly of the clip weight 10 by guiding the biasing member 20 into the desired connecting position, as will be discussed in greater detail below.

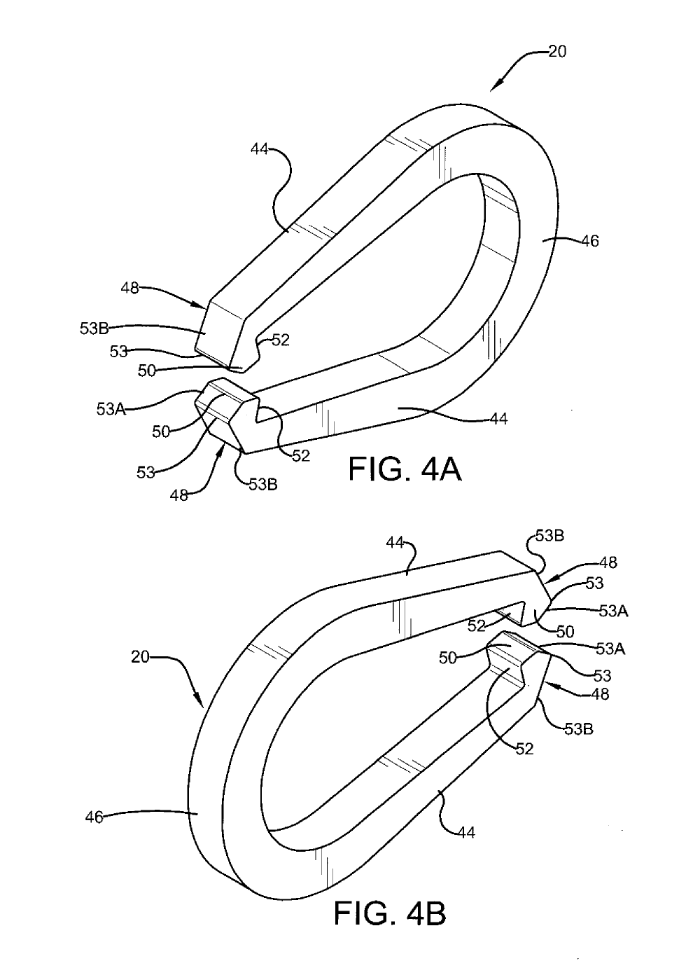

Referring now to FIGS. 4A and 4B, a biasing member 20 according to the concepts of the present disclosure is shown and described. The biasing member 20 includes arms 44 extending from each end of a generally U-shaped connecting portion 46, the arms terminating at ends 48. In an unactuated position, where no forces are acting on the biasing member 20, the arms 44 may extend toward one another. Stated differently, the arms 44 of the biasing member 20 may be angled relative to one another so that there is a greater distance between them proximate the connecting portion 46 than there is proximate the ends 48. In certain embodiments, the angle between the arms 44 may be substantially the same as the angle between the first and second clip members 12 and 14 when the clamping tabs 34 are contacting one another (FIG. 3).

A projection 50 may extend inwardly from the end 48 of each arm 44 toward the other end, the projection including a step 52 adapted to secure the biasing member to the recess 40 on each of the first and second clip members 12 and 14. In certain embodiments, the ends 48 of the biasing member 48 may terminate at a point 53 with angled surfaces 53a and 53b extending in opposing directions from the point. The angled surface 53a extending toward an interior of the biasing member 20, may be adapted to engage the ramped surfaces 42 of the clip members 12 and 14 during assembly. The step 52 may form an angle with the arm 44 that is equal to or less than 90° to facilitate a permanent attachment of the biasing member 20 to the clip members 12 and 14, the angle of the step 52 preventing the projections 50 from being unintentionally dislodged from the recesses 40.

In one or more embodiments, the biasing member 20 may be provided with a color. In certain embodiments, the color of the biasing member may be the same as the clip members 12 and 14. In other embodiments, the colors of the biasing member 20 and clip members 12 and 14 may be different. As will be appreciated by those skilled in the art, use of a thermoplastic material to form the biasing member 20 allows for greater customization as compared to the metal biasing members of prior art clip-style balloon weights.

In one or more embodiments, the biasing member 20, including the arms 44 and connecting portion 46, may have a generally square or rectangular cross sectional profile. This cross sectional shape may provide improved strength and performance to the biasing member 20. In one or more embodiments, the biasing member 20 may be made of a non-metallic material. In certain embodiments, the biasing member 20 may possess sufficient strength, elasticity and resilience to act as a spring, and to provide sufficient biasing force to clamp the clip weight 10 to a fixture. In certain embodiments, the biasing member 20 may be made of a thermoplastic material.

In one or more embodiments, the biasing member 20, and the thermoplastic material that forms the biasing member 20, may be characterized by a tensile strength measured according to ASTM D638 of at least approximately 6,000 psi, in other embodiments at least approximately 7,000 psi, in still other embodiments at least approximately 8,000 psi, in other embodiments at least approximately 9,000 psi, and in yet other embodiments at least approximately 10,000 psi. In certain embodiments, the biasing member 20, and the thermoplastic material that forms the biasing member 20, may be characterized by a tensile strength measured according to ASTM D638 of between 6,000 psi and 15,000 psi, in other embodiments between 8,000 and 13,000 psi, in still other embodiments between 9,000 and 12,000 psi, and in yet other embodiments between approximately 10,000 and 11,000 psi.

In one or more embodiments, the biasing member 20, and the thermoplastic material that forms the biasing member 20, may be characterized by a flexural modulus according to ASTM D790 of at least approximately 380,000 psi, in other embodiments at least approximately 400,000 psi, in other embodiments at least approximately 420,000 psi, in still other embodiments at least approximately 440,000 psi, and in yet other embodiments at least approximately 480,000 psi. In one or more embodiments, the biasing member 20, and the thermoplastic material that forms the biasing member 20, may be characterized by a flexural modulus according to ASTM D790 of between 380,000 and 600,000 psi, in other embodiments between 440,000 and 560,000 psi, in other embodiments between 460,000 and 540,000 psi, and in yet other embodiments between approximately 470,000 and 530,000 psi.

In one or more embodiments, the biasing member 20, and the thermoplastic material that forms the biasing member 20, may be characterized by a flexural strength according to ASTM D790 of at least approximately 11,000 psi, in other embodiments at least approximately 11,500 psi, in other embodiments at least approximately 12,000 psi, in still other embodiments at least approximately 12,500 psi, and in yet other embodiments at least approximately 13,000 psi. In one or more embodiments, the biasing member 20, and the thermoplastic material that forms the biasing member 20, may be characterized by a flexural strength according to ASTM D790 of between 11,000 and 15,500 psi, in other embodiments between 12,000 and 15,300 psi, in still other embodiments between 13,000 and 15,100 psi, and in yet other embodiments between 14,000 and 15,000 psi.

In a particular embodiment, the biasing member 20 may be formed from a polystyrene thermoplastic material. The polystyrene may be characterized by a tensile strength (Yield, 73° F.) of approximately 6300 psi according to ASTM D638. The polystyrene may be further characterized by a flexural modulus (73° F.) of approximately 460,000 psi according to ASTM D790. The polystyrene may be further characterized by a flexural strength (73° F.) of approximately 12,000 psi.

In another embodiment, the biasing member 20 may be formed from a Styrene Acrylonitrile (SAN) thermoplastic material. The SAN may be characterized by a tensile strength (Yield, 0.125 in) of approximately 10,600 psi according to ASTM D638. The SAN may be further characterized by a flexural modulus (0.250 in) of 520,000 psi according to ASTM D790. The SAN may be also be characterized by a flexural strength (0.250 in) of approximately 14,900 psi according to ASTM D790.

In yet another particular embodiment, the biasing member 20 may be formed from a polycarbonate thermoplastic material. The polycarbonate may be characterized by a tensile strength (Yield) of approximately 9280 psi according to ASTM D638. The polycarbonate may also be characterized by a flexural modulus of approximately 406,000 psi according to ASTM D790. The polycarbonate may also be characterized by a flexural strength of approximately 14,500 psi according to ASTM D790.

While a particular clip structure is described herein, it is also contemplated that additional features may be included without deviating from the scope of the present invention. For example, a spool or additional weight pieces for providing added weight, as disclosed in U.S. Pat. No. 7,850,506, which is incorporated herein by reference, may also be provided as a part of clip weight 10.

Referring now to FIGS. 5A-5C, a method of assembling a clip weight 10 according to the present disclosure will be discussed. The first and second clip members 12 and 14 may first be positioned adjacent one another so that the clamping tabs 34 are contacting one another, and the hinge mechanisms 16 and 18 are engaged and properly positioned (see FIG. 5B).

The biasing member 20 may then be inserted with the ends 48 pointing toward the clip end 22. As the ends 48 of the biasing member 20 contact and engage the ramped surfaces 42, the biasing member is caused to flex and open to that the ends 48 of the arms 44 move away from one another (see FIG. 5B). It should be appreciated that the slots 28 of the first and second clip members 12, 14 allow for unimpeded insertion of the biasing member 20 toward the ramped surfaces 42 and expansion outwardly due to the opening of the biasing member caused by the ramped surfaces 42. Additionally, the slots 28 provide clearance for the biasing member to flex or deform when the squeeze end is engaged to open the clip end and overcome the biasing force.

Once the step 52 of the projection 50 on each of the ends 48 has passed the peak 43 of the ramped surfaces, the projections 50 on each arm 44 will “snap” into the recesses 40 of the first and second clip members 12, 14 (see FIG. 5C). The recesses 40 may be appropriately sized and shaped to receive the projections 50 therein. The intimate relationship between the projections 50 and the recesses 40 of the assembled clip weight 10 prevents easy removal of the biasing member 20, and may, in certain embodiments, require destruction of the clip-weight to disengage the biasing member 20 from the clip members 12, 14 after assembly. The biasing force of the biasing mechanism 20 will prevent the projections 50 from being removed from the recesses 40 under normal conditions. Notably, in a side profile (e.g. FIG. 5C) the arms 44 of the biasing mechanism do not extend appreciably outwardly beyond the body 26 of the first and second clip members 12 and 14 in an unactuated state, thereby providing a clip weight 10 that is sleeker and consumes less space as compared to conventional clip-style weights. This sleek appearance is due in part to the angle between the arms 44 of the biasing member being approximately equal to the angle between the bodies 26 of the first and second clip members 12 and 14.

It is thus evident that clip-style balloon weight constructed as described herein substantially improves the art. Only particular embodiment(s) have been presented and described in detail, and the invention should not be limited by the drawings or the description provided. For an appreciation of the true scope and breadth of the invention, reference should be made only to the following claims.

What is claimed is:

1. A balloon weight comprising:
(a) a first clip member;
(b) a second clip member pivotable relative to said first clip member; and
(c) a generally U-shaped biasing member engaged with both said first and second clip members to bias said clip members into touching engagement at a clip end and away from one another at a squeeze end, the biasing member being formed of a non-metallic material.

2. The balloon weight of claim 1, wherein said biasing member includes first and second arms extending from opposite ends of an arcuate connecting portion, the arms extending toward one another as the extend away from the connecting portion.

3. The balloon weight of claim 2, wherein said arms each include an end having an inwardly extending projection adapted to engage a portion of one of the first and second clip members.

4. The balloon weight of claim 1, wherein said biasing member is formed of a thermoplastic material having a tensile strength measured according to ASTM D638 of at least approximately 6,000 psi.

5. The balloon weight of claim 1, wherein said biasing member is formed of a thermoplastic material having a flexural modulus measured according to ASTM D790 of at least approximately 380,000 psi.

6. The balloon weight of claim 1, wherein said biasing member is formed of a thermoplastic material having a flexural strength measured according to ASTM D790 of at least approximately 11,000 psi.

7. The balloon weight of claim 1, wherein said biasing member is formed of styrene acrylonitirile.

8. A balloon weight comprising:
(a) a first clip member having a recess and a ramped surface adjacent said recess;
(b) a second clip member having a recess and a ramped surface adjacent said recess, said second clip member being pivotable relative to said first clip member;
(c) a biasing member including arms extending from opposite ends of an arcuate connecting portion, each arm including a projection at an end opposite the connecting portion received in one of the recesses of the first and second clip members.

9. The balloon weight of claim 8, wherein said first and second clip members each include a slot extending longitudinally from a forward end adjacent a clamp end and a rearward end adjacent a squeeze end.

10. The balloon weight of claim 9, wherein said recesses of said first and second clip members are positioned adjacent to said forward ends of said slots, and said biasing member acts to bias said clip members into contact and engagement at said clamp end.

11. The balloon weight of claim 10, wherein said first and second clip members are pivotally connected to one another by one or more hinge connections positioned between said clamp end and said squeeze end.

12. The balloon weight of claim 9, wherein said arms of said biasing member are at least partially positioned within said slots of said first and second clip members to allow for flexing or deformation of the biasing member.

13. The balloon weight of claim 8, wherein said biasing member is formed of a non-metallic material.

14. The balloon weight of claim 8, wherein a hole is provided in one of said first or second clips adjacent said squeeze end for attachment of a string or ribbon.

15. The balloon weight of claim 8, where said biasing member has a rectangular cross sectional shape.

16. A method of assembling a balloon weight comprising the steps of:
(a) positioning first and second clip members together so that clip ends of the clip members are in contact and hinge portions of the clip members engage one another to pivotally connect the clip members, each of the clip members including a recess and a ramped surface extending from the recess;
(b) applying a force adjacent to the clip ends to maintain the clip members in position; and
(c) inserting a biasing member between the clip members toward the clip end, the biasing member including inwardly extending projections at opposing ends adapted to engage the ramped surfaces of the clip members to guide the projections into the recesses, thereby securing the biasing member to the clip members.

17. The method of claim 16, wherein the clip members each include a slot, and the step of inserting includes positioning the biasing member to extend into each of the slots.

18. The method of claim 16, wherein the biasing member includes arms extending from opposing ends of an arcuate connecting portion.

19. The method of claim 16, wherein said biasing member is formed of a non-metallic material.

20. The method of claim 16, wherein the projections include a step to prevent the biasing member from being withdrawn from the recesses.
